(19) United States
(12) Patent Application Publication
(10) Pub. No.: US 2015/0217823 A1
(43) Pub. Date: Aug. 6, 2015

(54) BICYCLE STORAGE DEVICE

(71) Applicant: Christopher Neil Willetts, Milford, MI (US)

(72) Inventor: Christopher Neil Willetts, Milford, MI (US)

(21) Appl. No.: 14/612,724

(22) Filed: Feb. 3, 2015

Related U.S. Application Data
(60) Provisional application No. 61/935,039, filed on Feb. 3, 2014.

(51) Int. Cl. B62H 3/00; B62K 25/02

(52) U.S. Cl. CPC B62H 3/00; B62K 25/02; B62K 2206/00

(57) ABSTRACT

The present invention provides a bicycle storage device for use with a bicycle having a removable front wheel that is rotatably mounted to a pair of front fork legs. The storage device comprises a mounting bar that extends between the front fork legs, and the mounting bar includes a mounting bracket having an opening for receiving and temporarily retaining an end of the front wheel's axle. The opening has an axis that is oriented at an angle with respect to the mounting bar. Preferably, the axis of the opening and the mounting bar are oriented substantially perpendicular to each other.

### CROSS-REFERENCE TO RELATED APPLICATIONS

This application is a completion application and claims the benefit of co-pending U.S. Provisional Application Ser. No. 61/935,039, filed Feb. 3, 2014 for “Bicycle Storage Device”, the disclosure of which is hereby incorporated by reference, including all drawing figures.

### BACKGROUND OF THE INVENTION

1. Field of the Invention

The present invention pertains to a device that aids in storing a bicycle. More particularly, the present invention pertains to a bicycle storage device that allows the front wheel to be removed and temporarily secured to the front fork legs at an angle that is substantially parallel to the bicycle's handlebars, thereby reducing the overall width of the bicycle for storage.

2. Description of the Prior Art

Bicycles are a popular form of transportation, particularly in high-density urban locations and universities. In those locations storage space for bicycles is often at a premium. As a result, many bicyclists are forced to store their bicycles in close quarters like a dormitory room or an apartment. And unfortunately, bicycles are inherently awkward or inconvenient to store because the handlebars protrude laterally and are much wider than the rest of the bicycle. Bicycles would be much easier to store if it were not for the protruding handlebars. Not only do the wide handlebars make the bicycle difficult to store, but they can also make the bicycle more difficult to navigate indoors, such as when the bicyclist walks the bicycle through the front lobby of their residence building up to their apartment.

There have been previous attempts to make bicycles that are easier to store. For example, U.S. Pat. No. 6,425,598 to Murayama discloses a foldable bicycle that reduces the overall size of the bicycle for storage. Although this reduces the size of the bicycle for storage, this requires the bicycle rider to purchase an entirely new bike in order to utilize the benefits of that invention, and most bicyclists like their existing bike and would prefer a storage solution that makes it easier to store the bicycle that they already own. Many bicyclists own their bicycle because of certain performance characteristics that the bike has, and they would not be interested in “downgrading” the bicycle just because it is easier to store.

There are other devices that make it easier to store a bicyclist's existing bicycle by narrowing the handlebars. For example, U.S. Pat. No. 5,570,614 to Nastrucci discloses handlebars that can be loosened and folded inwardly toward the centerline of the bicycle for storage. However, this requires installing these particular handlebars onto one's existing bicycle. But again, this requires the bicyclist to modify their bicycle in a way that they may not want to for performance or aesthetic reasons. There could also potentially be safety issues associated with tightening and re-tightening the handlebars from the riding position to the storage position and back again if the handlebars are not adequately secured in position while the bicyclist is riding the bike.

Another device for adjusting the handlebar location is disclosed in U.S. Pat. No. 7,296,813 to Montague et al. Montague discloses a handlebar stem and headset for a bicycle that allows the bicycle's stock handlebars to be temporarily removed and re-installed onto the stem at a 90° angle from the riding position so that the handlebars align with the front wheel. However, this again requires fairly substantial modification to the existing bicycle's structure, and many bicyclists are not inclined to modify their bicycle in such a manner, especially those bicyclists that have a high performance or expensive bicycle.

Thus, there remains a need to decrease the overall width of a bicycle for storage which is quick and easy to use, but which does not require any modification to the mechanical structure of the existing bicycle.

The present invention, as is detailed hereinbelow, seeks to improve upon existing bicycle storage solutions by providing a bicycle storage device that allows the front wheel of the bike to be removed and temporarily secured to the front fork legs at an angle that is substantially parallel to the bicycle's handlebars, thereby reducing the overall width of the bicycle for storage.

### SUMMARY OF THE INVENTION

The present invention provides a bicycle storage device for use with a bicycle having a removable front wheel that is rotatably mounted to a pair of front fork legs. The storage device comprises a mounting bar that extends between the front fork legs, and the mounting bar includes a mounting bracket having an opening for receiving and temporarily retaining an end of the front wheel's axle. The opening has an axis that is oriented at an angle with respect to the mounting bar. Preferably, the axis of the opening and the mounting bar are oriented substantially perpendicular to each other.

According to another aspect hereof, the present invention provides a method of narrowing the width of a bicycle for storage by aligning the front wheel with the handlebars comprising: (a) providing the bicycle storage device described above; (b) removing the front wheel from the bicycle; (c) securing the mounting bar of the bicycle storage device between the bicycle's front fork legs; (d) inserting an end of the front wheel's axle into the opening on the mounting bracket of the storage device; and (e) tightening the front wheel's axle to the mounting bracket, whereby the front wheel is temporarily secured to the bicycle such that the front wheel and the handlebars are aligned with each other, and as a result, the width of the bicycle has been reduced for storage.

Optionally, the opening in the mounting bracket comprises an open-ended slot for receiving one end of the removed wheel's axle.

Optionally, there is also provided a spacer that is placed onto the wheel's axle. The spacer is placed on the end of the axle that is opposite the end that is secured to the mounting bracket.

Optionally, the mounting bar has a hollow bore extending through the length of the bar, and there is also provided a quick-release skewer having a shaft that extends through the bore. The quick-release skewer allows the mounting bar to be quickly and easily secured to the bicycle's front fork legs.

Optionally, at least one end of the mounting bar has a raised ridge forming a key that is aligned with a slotted opening in the respective front fork leg, whereby the key aligns in the front fork leg's slotted opening and the mounting bar cannot rotate when secured between the fork legs.

Optionally, the orientation of the mounting bracket can be adjusted about the elongated axis of the mounting bar to adjust the angle of the removed front wheel with respect to the bicycle.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a bicycle in the prior art;

FIG. 2 is a perspective view of a first embodiment of the invention installed on the front fork legs of a bicycle, this view showing the front wheel being aligned with the handlebars when the present invention is installed on a bicycle;

FIG. 3 is a perspective view of the first embodiment of the invention installed on a bicycle;

FIG. 4 is a second perspective view of the first embodiment of the invention installed on a bicycle;

FIG. 5 is a third perspective view of the first embodiment of the invention installed on a bicycle showing the bicycle and front wheel in phantom;

FIG. 6 is a perspective view showing a second embodiment of the bicycle storage device dissembled;

FIG. 7 is a second perspective view showing a second embodiment of the bicycle storage device;

FIG. 8 is a third perspective view showing a second embodiment of the bicycle storage device;

FIG. 9 is fourth perspective view showing a second embodiment of the bicycle storage device;

FIG. 10 is a front view of a bicycle with the bicycle storage device installed, this view showing the angle α between the bicycle and the front wheel;

FIG. 11 is a perspective view showing the key on an end of the mounting bar being aligned with the C-shaped bracket on the end of a fork leg;

FIG. 12 is a top side view of a second embodiment of the bicycle storage device showing the angle θ between the axis of the opening in the mounting bracket and the lengthwise axis of the mounting bar;

FIG. 13 is a perspective view of an alternative embodiment of the spacer in which the spacer comprises two separate pieces;

FIG. 14 is a second perspective view of the alternate embodiment of the spacer showing the two spacers oriented with respect to each other so as to encircle the shaft of a quick-release skewer, the shaft not being shown in this figure;

FIG. 15 is a perspective view showing a third embodiment of the bicycle storage device;

FIG. 16 is a front side view of the mounting bar and the mounting bracket from the third embodiment of the bicycle storage device;

FIG. 17 is a perspective view of the mounting bar and the mounting bracket from the third embodiment of the bicycle storage device; and

FIG. 18 is a left side view of the mounting bar and the mounting bracket from the third embodiment of the bicycle storage device.

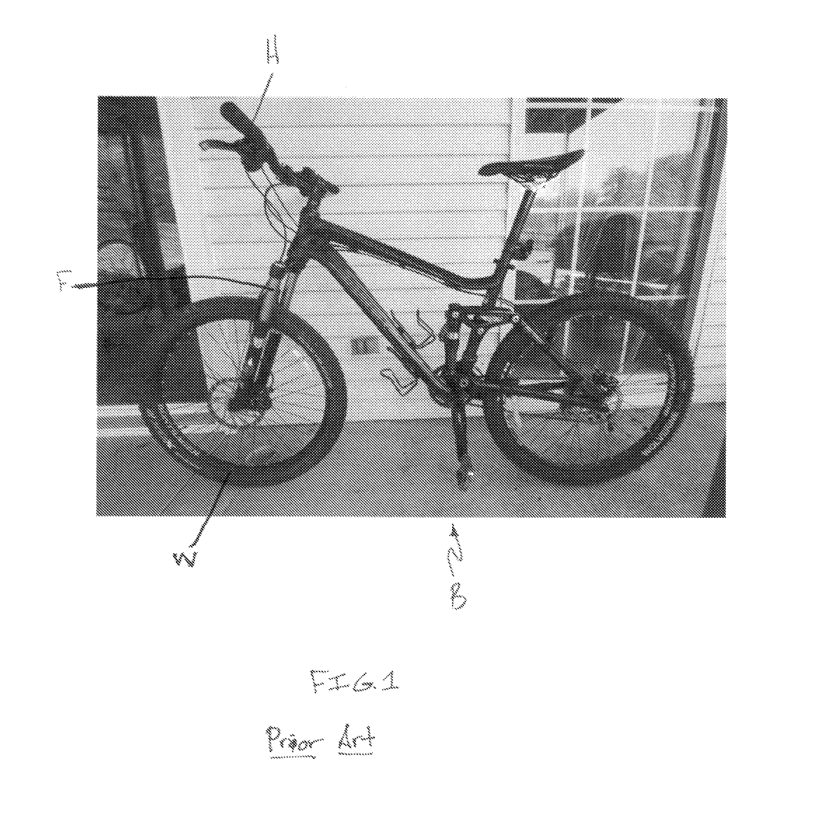

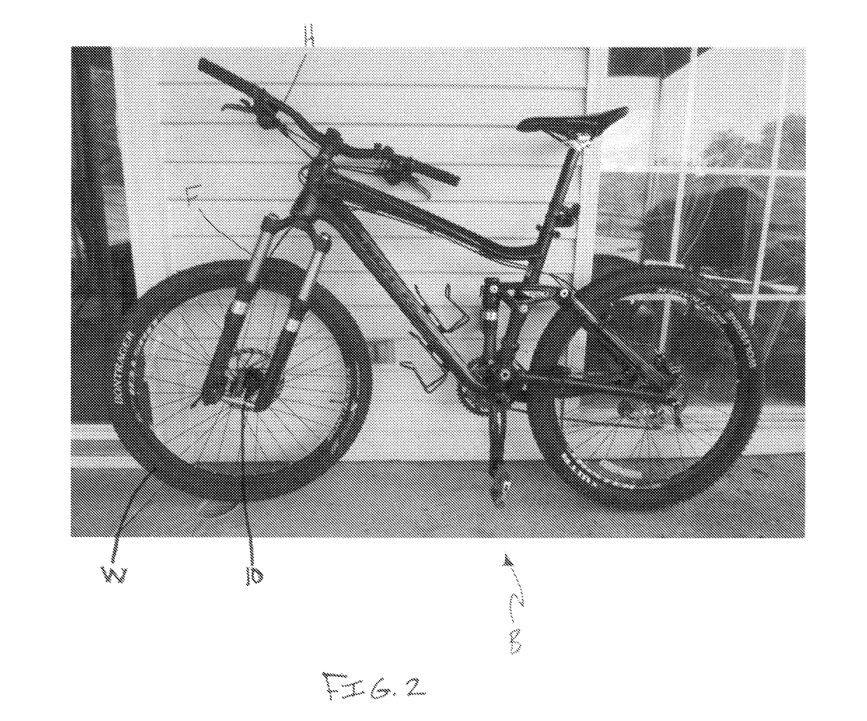

### DETAILED DESCRIPTION OF THE PREFERRED EMBODIMENT

In accordance with the present invention, there is provided a bicycle storage device 10 for use with a bicycle B having a removable front wheel W that is rotatably mounted to a pair of opposed front fork legs F. The bicycle storage device 10 is for use with any conventional bicycle having a frame, a pair of opposed front fork legs, a front wheel having an axle that is rotatably secured between the front fork legs, and handlebars H that are fixedly connected to the front fork legs to steer the bicycle.

The bicycle storage device 10, as described hereinbelow, can be temporarily installed, or retained, between the front fork legs after the front wheel has been removed from the fork legs. The device 10 is temporarily secured between the fork legs, and the front wheel is then installed onto the mounting bracket 12 of the device. The mounting bracket 12 is oriented such that the front wheel is then positioned substantially perpendicular to the front wheel's usual orientation on the bicycle. As a result, the handlebars are aligned with the front wheel which reduces the overall width of the bicycle for storage.

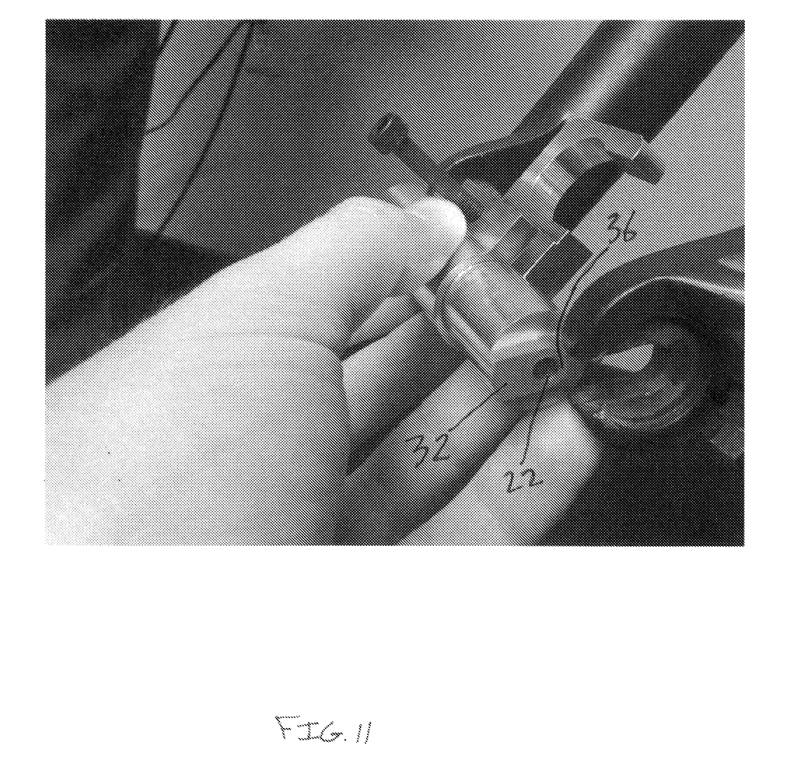

The storage device 10 comprises a mounting bar 14. The mounting bar 14 is a rigid piece of material having an elongated length and being longer than it is wide. The mounting bar 14 has an elongated axis shown as x in FIG. 12. The mounting bar 14 can be any suitable shape, including a bar having a square or rectangular cross-sectional area, a cylindrical rod having a circular or oval-shaped cross-sectional area, and so forth. It should also be noted that the mounting bar 14 does not need to have a continuous, or consistent, cross-sectional shape extending along the length thereof. Preferably, and as shown throughout the drawings, the mounting bar 14 is cylindrical and has a substantially circular cross-sectional area along the length thereof.

The mounting bar 14 includes a pair of opposed ends 16 and a medial section 18 near the middle of the bar 14. The mounting bar 14, as well as any of the other components of the storage device 10 described hereinbelow, can comprise any suitable type of material, including metal, plastic, composite materials, and the like. As described in greater detail below, the mounting bar 14 must support some weight from the front half of the bicycle, and therefore the mounting bar 14 is preferably formed from metal or a high-strength polymer. Even more preferably, the storage device 10 comprises a metal material like steel or aluminum. It is also preferable that the storage device 10 components comprise a corrosion-resistant material, such as stainless steel, aluminum, or a polymer-based material.

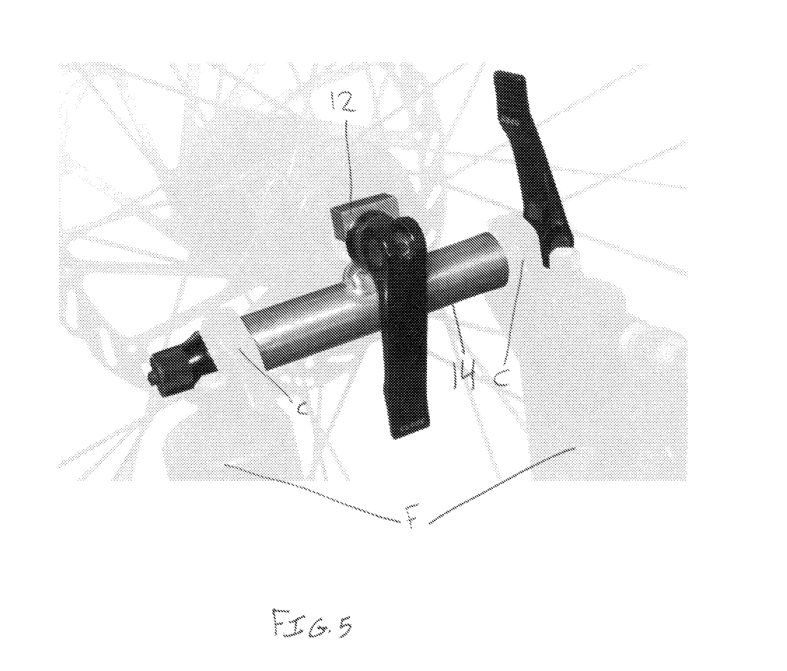

As understood by those having ordinary skill in the art and shown best in FIGS. 5 and 11, the bottom end of each front fork leg includes an open-ended brace or C-shaped bracket C for receiving the front wheel's axle. It is also well-known to those having ordinary skill in the art that the axle on the front wheel of many bicycles includes a quick-release skewer to quickly and easily remove and re-install the front wheel from the bicycle without the use of any additional tools. The front wheel is often removed to change the tire, for storage, or for transportation. Many roof racks on cars for carrying bicycles require the front wheel to be removed when the bicycle is secured to the roof rack.

As a result, many bicyclists are very familiar using the quick-release skewer to remove and re-attach the front wheel of their bicycle. Quick-release skewers are well-known in the art, such as the types disclosed in U.S. Pat. No. 4,033,627 to Morroni and U.S. Pat. No. 3,922,018 to Shook, the disclosures of which are hereby incorporated by reference. Generally speaking, a quick-release skewer 20 includes a central shaft 24 that has a nut member 26 rotatably connected to one end of the shaft 24, and a cam lever 28 pivotally attached to the other end. A floating nut member 27 is positioned on the shaft 24 next to the cam lever 28. The shaft 24 of the quick-release skewer 20 is positioned through the front wheel's hub. The front wheel is then positioned onto the fork ends of the front fork legs, and the cam lever 28 is turned, thereby driving the nut members, 26 and 27, against the C-shaped brackets and securing the front wheel onto the fork legs.

Turning back to the invention, there is provided means for retaining 21 the mounting shaft between the fork ends of the bicycle. Preferably the means for retaining 21 includes two opposed engaging members that are secured to the opposed ends of the shaft 24. The shaft 24 is positioned within, and extends through, the hollow bore 22. The engaging members function to compress the fork ends of the front fork between the respective engaging members and the mounting bar 14, thereby securing the mounting bar 14 between the fork ends of the front fork. The engaging members can be fixedly connected to the ends of the shaft, they can be threadably connected to the ends, or connected by any other mechanical device or coupling apparatus which is well-known to those having ordinary skill in the art and would be considered equivalents thereof under 35 U.S.C. §112 (6^{th} paragraph).

Even more preferably, the means for retaining 21 comprises a quick-release skewer 20, such as the type described generally above. The shaft 24 freely rotates within the bore 22, and the shaft 24 is threadably attached to a nut member 26 at at least one end. The threaded nut member 26 is then rotated on the threads to drive the nut member 26 toward the mounting bar 14 and the cam lever 28 is rotated, thereby temporarily securing the mounting bar 14 into the C-shaped brackets (or fork ends) and between the fork legs. It is to be appreciated by those having ordinary skill in the art that the quick-release skewer 20 allows the mounting bar 14 to be quickly and easily secured to the bicycle's front fork legs without the use of any tools.

Preferably, at least one end 16 of the mounting bar 14 has a key 32 that is dimensioned to mate with the C-shaped bracket on the end of the front fork, as shown in FIG. 11. The key 32 extends outwardly lengthwise from the end 16 of the bar 14 and forms a raised ridge, or strip, near the axially-central portion of the end 16. The bore 22 preferably extends through the key 32. The key 32, being mated to fit inside the C-shaped bracket, keeps the bar 14 from rotating when the 14 bar is secured between the C-shaped brackets. Optionally, both ends 16 of the mounting bar 14 include a key 32.

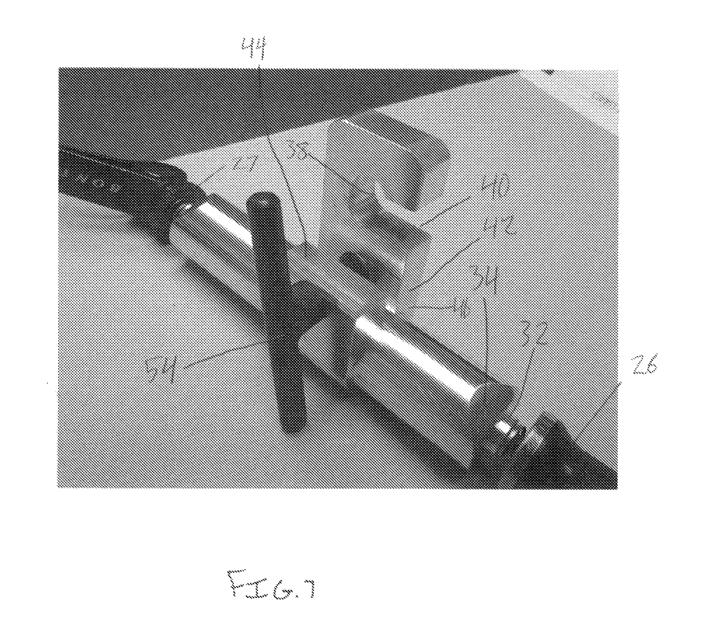

Optionally, at least one end 16 of the bar 14 includes a beveled, or notched, shoulder 34. As shown in FIG. 7, the beveled shoulder 34 is positioned near a top 36 of the key 32, and the beveled shoulder 34 is provided to assist in positioning the bar 14 between the C-shaped brackets on the fork legs. Preferably, both ends 16 of the bar 14 have a beveled shoulder 34.

There is also provided a mounting bracket 12 that is secured to the medial section 18 of the mounting bar 14. The mounting bracket 12 has an opening 38 for receiving an end of the front wheel's axle, much like the C-shaped bracket receives the end of the front wheel's axle when the bicycle is in use. The shaft 24 of the quick-release skewer 20 extends through the opening 38, and the threaded nut member 26 is positioned on one side of the mounting bracket 12 and the front wheel's hub is positioned on the other side of the mounting bracket 12. The opening 38 has an axis y that is oriented at an angle θ with respect to the mounting bar 14. Although it will be understood more fully once the method of use of the bicycle storage device 10 has been discussed, the angle θ dictates the angle between the handlebars and the front wheel when the bicycle storage device 10 is in use. Preferably, the axis y of the opening 38 and axis x of the mounting bar 14 are oriented substantially perpendicular to each other, however any suitable angle can be chosen. Preferably, any angle from 45° to 90° is suitable, although approximately 90° is even more preferred.

The opening 38 in the mounting bracket 12 preferably comprises an open-ended slot 40 for receiving one end of the removed wheel's axle, the slot 40 being open-ended so that the quick-release skewer 20 can be positioned within the opening 38 without removing the threaded nut member 26 from the end of the shaft 24.

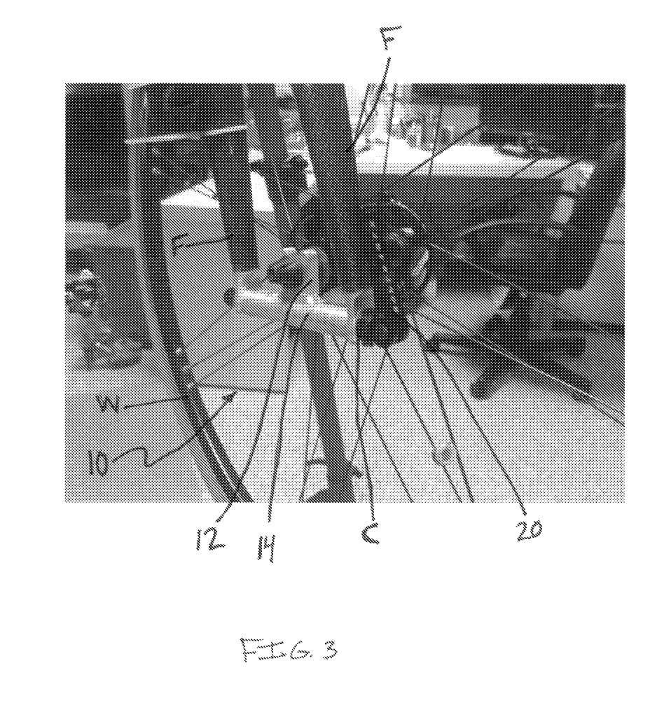

In the embodiment shown in FIGS. 3-5, the mounting bracket 12 is fixedly connected to the mounting bar 14, such as by being welded.

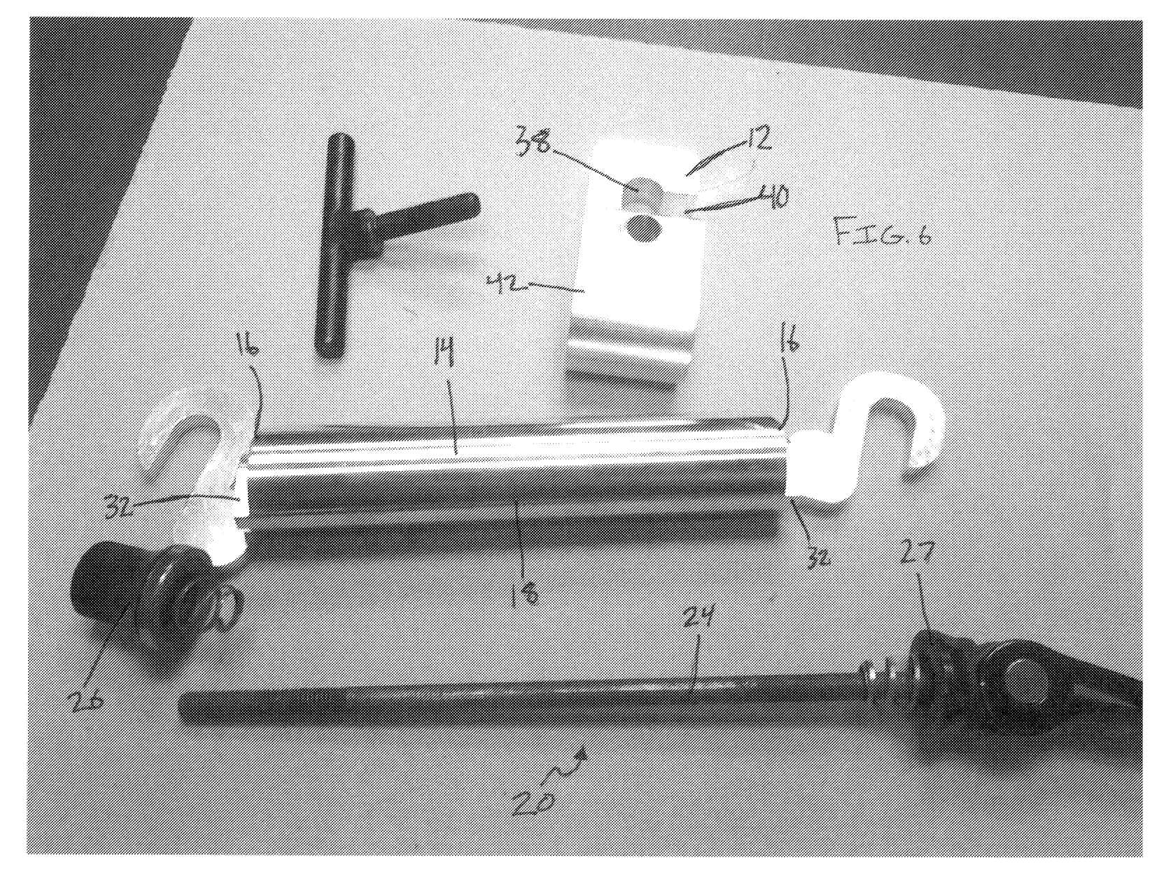

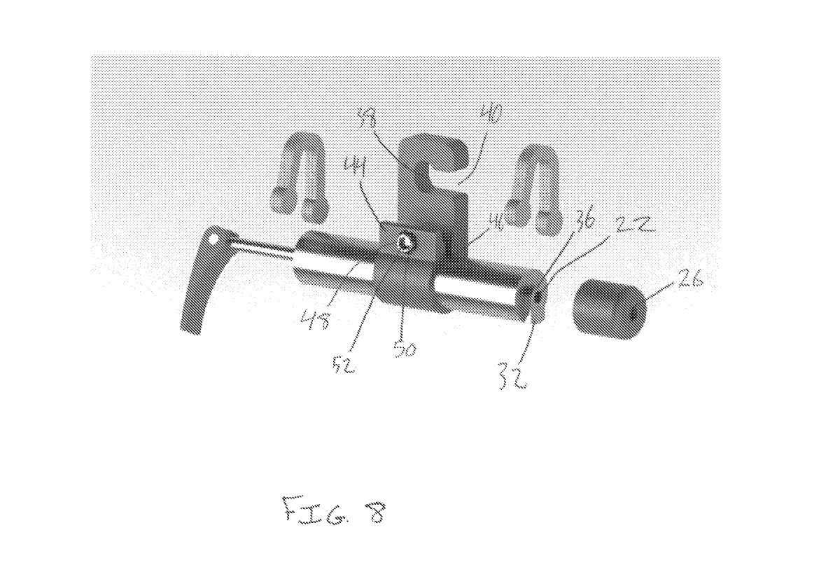

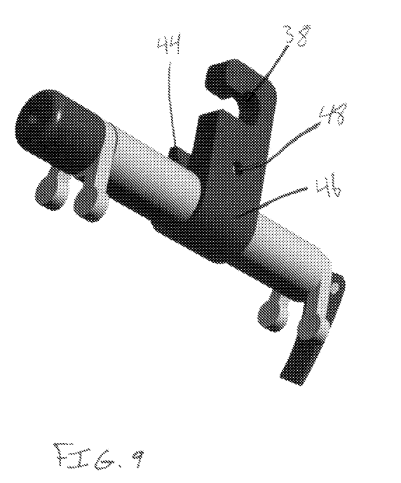

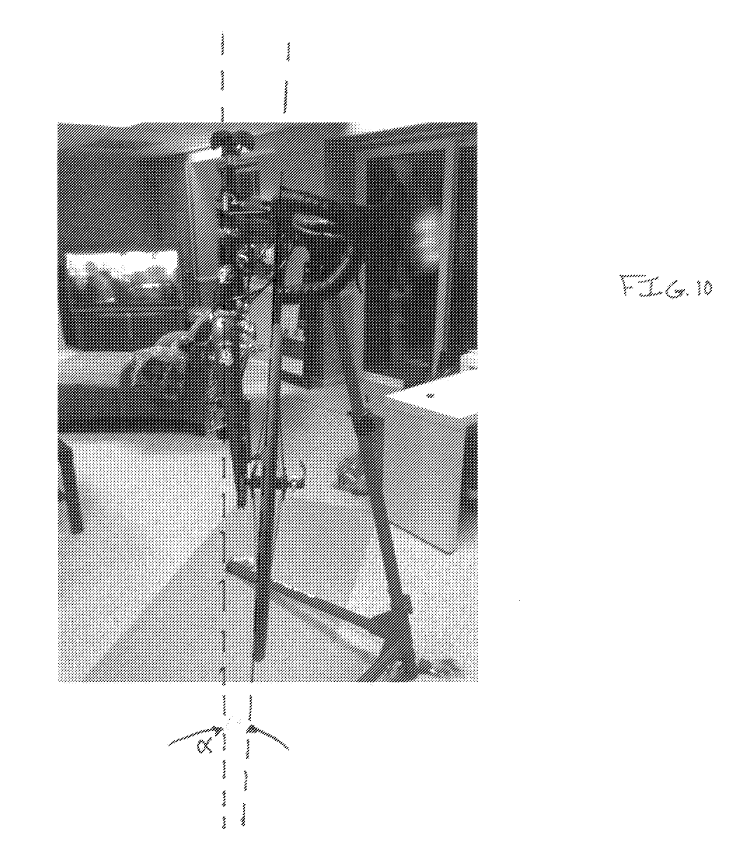

However, in the preferred embodiment shown in FIGS. 6-9, the orientation of the mounting bracket 12 can be adjusted about the elongated axis x of the mounting bar 14 to adjust the α of the removed front wheel with respect to the bicycle. This angle α is shown in FIG. 10 which adjusts the pitch of the front wheel with respect to the bicycle when the storage device 10 is in use. It is understood by those having ordinary skill in the art that the front fork legs on various types of bicycles are oriented at differing angles with respect to the ground. Thus, the mounting bracket 12 is adjustable about the mounting bar 14 to adjust the pitch angle of the front wheel with respect to the bicycle to adjust for the angle of the front fork legs with respect to the ground. As shown in the embodiment in FIGS. 7-9, the mounting bracket 12 includes a circular open-ended clamp 42 that encircles the mounting bar 14. The clamp 42 includes a distal section 44 and a base section 46, the distal and base sections 44,46 each having through-holes 48 that are aligned with each other. The through-hole 48 on the base section 46 is preferably threaded, and a threaded fastener 50 extends through the hole 48 in the distal section 44 and into the threaded hole 48 in the base section 46. The mounting bracket 12 is adjusted along the length of the mounting bar 14 and/or about the circumference of the mounting bar 14, and is then locked into position by tightening the fastener 50, which draws the distal section 44 of the clamp 42 against the base section 46, locking the mounting bar 14 and mounting bracket 12 to each other. The threaded fastener 50 preferably comprises a screw having any suitable type of head 52. The screw head 52 can include a handle 54 so that the mounting bracket 12 can be quickly and easily adjusted by hand, or it can include any other suitable type of head so that it can be adjusted by a screw driver, an Allen wrench, or the like. Once the position of the mounting bracket 12 has been adjusted for any particular bicycle, it should not need to be adjusted again.

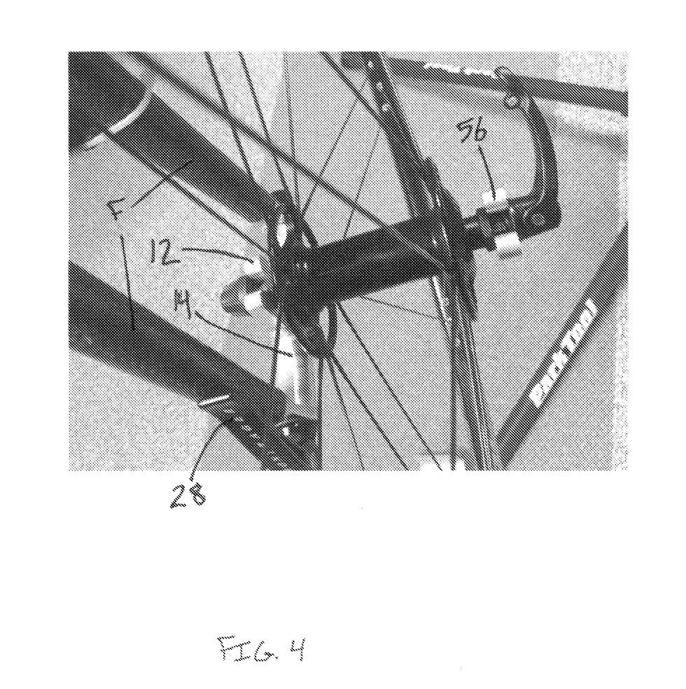

Optionally, as shown in FIG. 4, there is also provided a spacer 56 that is inserted onto the end of the front wheel's axle opposite the end of the wheel's axle that is secured to the mounting bracket 12. The spacer 56 can include a hook 62, or C-shaped section for encompassing the shaft 24 of the quick-release skewer 20 on the front wheel.

As understood by those having ordinary skill in the art, the tension applied by the means for retaining 21 on the front wheel can be fine-tune adjusted, such as by rotating the threaded nut member 26 on the threaded end of the shaft 24 when the means for retaining 21 comprises the threaded nut member 26. In addition, when the front wheel is secured to the front fork legs, the C-shaped brackets are positioned on each side of the wheel. As a result, the quick-release skewer 20 (when provided) can be fine-tuned to encompass and clamp down on two separate C-shaped brackets. When the storage device 10 is used, the quick-release skewer 20 on the front wheel is inserted on the mounting bracket 12, and the thickness of the mounting bracket 12 is intended to be the same or similar as the thickness of the C-shaped bracket. In order for the quick-release skewer 20 to be able to be clamped onto the mounting bracket 12 quickly and without significant adjustment to the threaded nut member 26, the spacer 56 is provided and placed over the quick-release skewer's shaft 24 on the end that is opposite to the mounting bracket 12. The total thickness of the mounting bracket 12 and the spacer 56 should be approximately the same as the total thickness of the two C-shaped brackets on the fork legs.

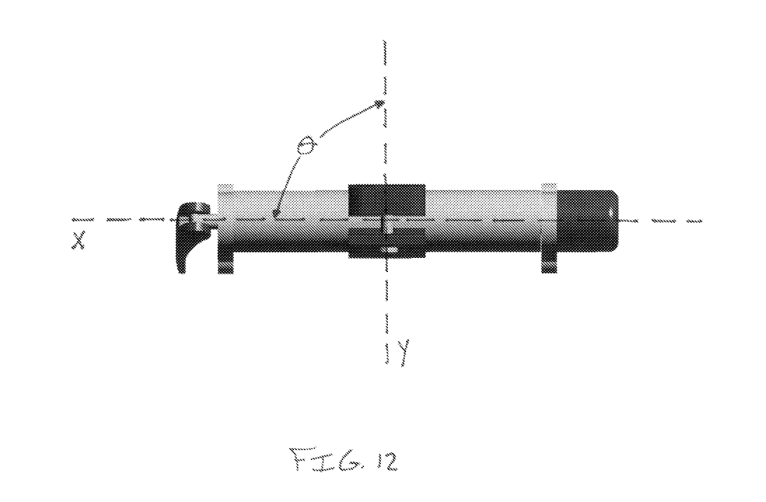

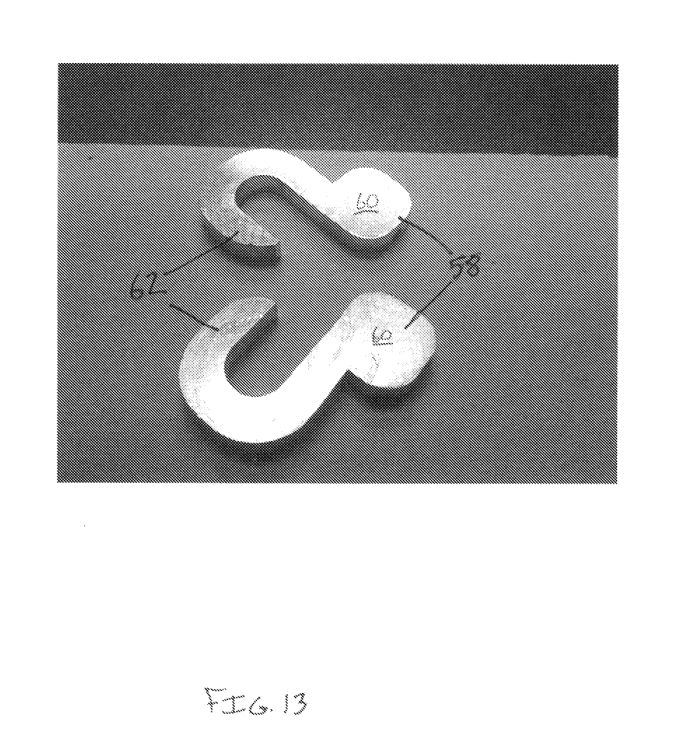

Optionally, and as shown in FIGS. 13 and 14, the spacer 56 can comprise two identical spacers, 56a and 56b, each having a hook 62 and a lower section 58. Each of the lower sections 58 can comprise a magnetic material 60 so that the two spacers 56a and 56b are attracted to each other. In use, the spacers 56a and 56b engage and hook around the shaft 24 from opposite directions as shown in FIG. 14, and the magnetically-attracted lower sections 58 draw the two spacers 56a and 56b together so that the spacers work to fully encircle the shaft 24 so that the spacers cannot fall off the shaft 24.

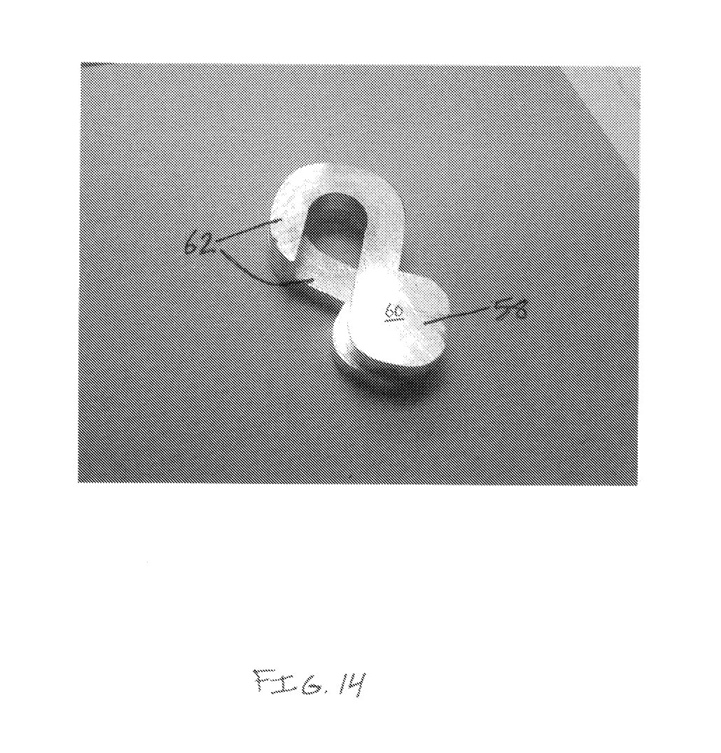

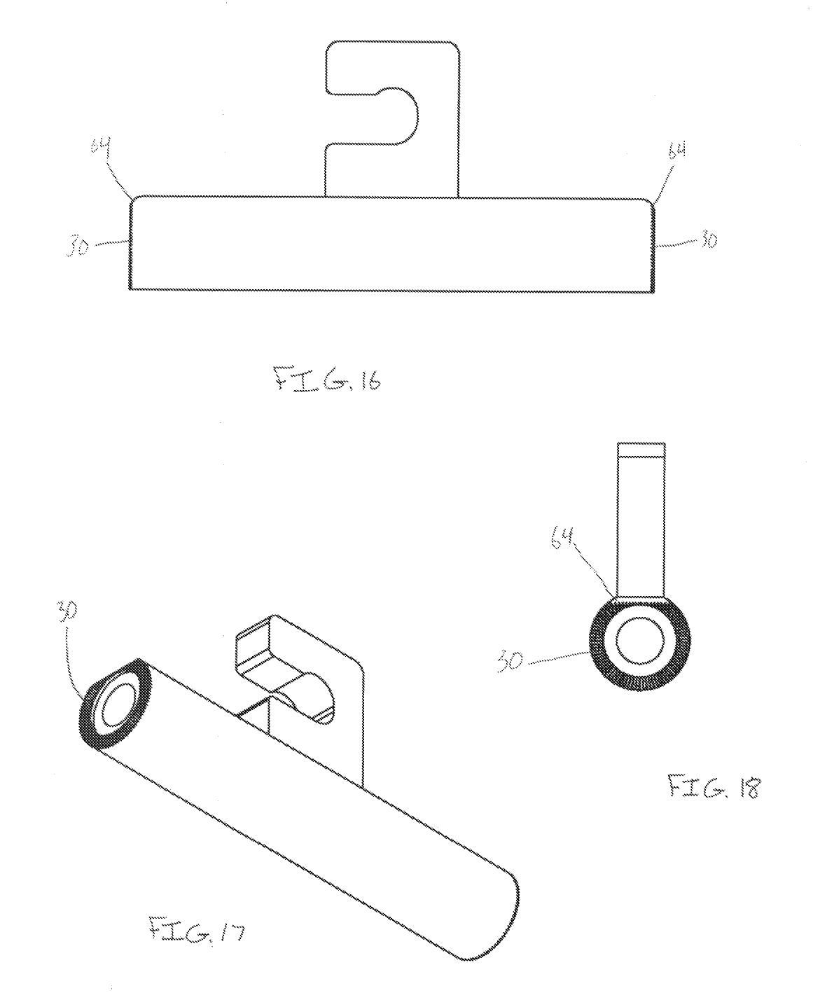

Another embodiment of the bicycle storage device 10 is shown in FIGS. 15-18. According to this embodiment, each of the ends 16 has a contoured surface 30 to engage the C-shaped brackets. The contoured surface 30 is supplied in lieu of the key 32, and the contoured surface 30 provides a rough, or abrasive surface to engage against the C-shaped brackets when the means for retaining 21 secures the mounting bar 14 between the ends of the forks legs. In particular, the contoured surface 30 can include a serrated surface such as shown in FIGS. 17 and 18), a knurled surface, or any other suitable type of rough surface.

Optionally, the ends 16 (or the entire bar 14) can be treated to further resist corrosion or wear. For instance, if the mounting bar 14 is formed from aluminum, then the ends 16 can be anodized. There are various other suitable manufacturing methods that can used. For example, the mounting bar 14 can be formed from extruded aluminum, and then the bar 14 can be machined and anodized. The ends 16 can then have steel serrated caps or inserts attached thereto. Another manufacturing method could be wherein the bar 14 is formed from casted steel or aluminum, and the ends 16 are hardened serrated edges, or steel inserts. Yet another possible manufacturing method could use overlay molding in which the bar 14 is formed from a plastic, or polymeric-based material, and ends 16 include steel serrated edges that are impregnated within the plastic. It is to be understood that these manufacturing methods are only exemplary, and the present invention is intended to encompass all suitable types of manufacturing methods.

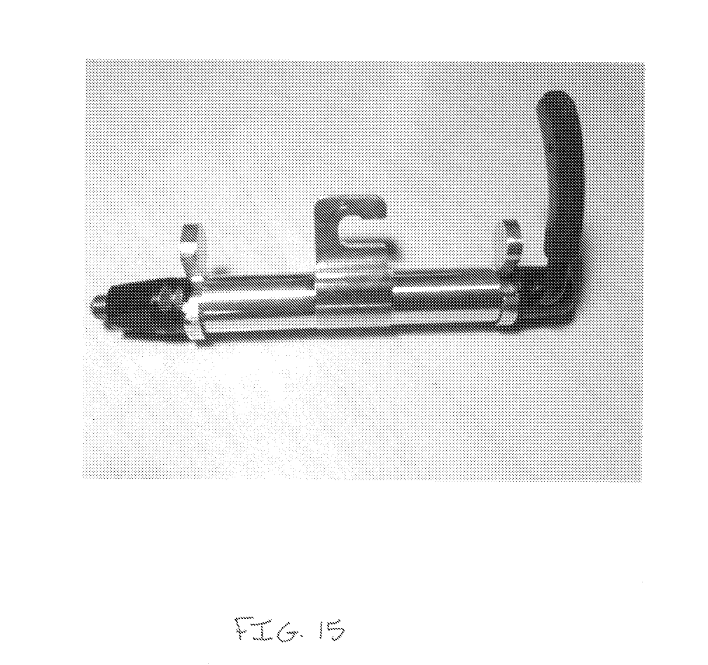

In addition, the bicycle storage device 10 can include a fillet 64 at each end 16, as shown best in FIGS. 16 and 18. The fillet 64 assists with positioning the mounting bar 14 between the C-shaped brackets, or fork ends on the bicycle.

According to another aspect hereof, the present invention provides a method of narrowing the width of a bicycle for storage by aligning the front wheel with the handlebars comprising: (a) providing the bicycle storage device 10 generally described above; (b) removing the front wheel from the bicycle; (c) securing the mounting bar 14 of the bicycle storage device 10 between the bicycle's front fork legs; (d) inserting an end of the front wheel's axle into the opening 38 on the mounting bracket 12; and (e) tightening the front wheel's axle to the mounting bracket 12, whereby the front wheel is temporarily attached to the bicycle such that the front wheel and the handlebars are aligned with each other, and as a result, the width of the bicycle has been reduced for storage.

According to the invention described above, there is provided a bicycle storage device that allows the front wheel to be removed and temporarily secured to the front fork legs at an angle that is substantially parallel to the bicycle's handlebars, thereby reducing the overall width of the bicycle for storage. It is seen that the bicycle storage device described above can reduce the overall width of a bicycle by up to six inches or more, depending upon the width of the handlebars. As a result, the bicycle can be stored in many more locations than otherwise would be available. For example, the bicycle can possibly be hung on the back of a door, stored on a wall, or even stored in a location like a deep closet. In addition, if the bicyclist has several bicycles, then the bicycles can be stored much closer to each other than would otherwise be possible.

Furthermore, it is appreciated that the storage device can quickly and easily be used, and does not require the ongoing use of additional tools.

While the present invention has been shown in the drawings and fully described above with particularity and detail in connection with what is presently deemed to be the most practical and preferred embodiment(s) of the invention, it will be apparent to those of ordinary skill in the art that many modifications may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

1. A storage device for the front wheel of a bicycle, the bicycle having opposed forks, the forks of the type having open ends for mounting a bicycle wheel axle comprising:
(a) a mounting bar detachably secured to the open ends of the forks, the bar having a throughbore;
(b) means for retaining the mounting bar in the open ends of the forks, the means including:
(1) a threaded shaft extending through the bore and projecting beyond the ends thereof;
(2) a mounting nut threadably mounted onto the shaft intermediate a cam lever and one end of the mounting bar and being driven toward the one end of the mounting bar;
(3) a locking member disposed at the opposite end of the shaft for locking the mounting bar to the forks;
(c) an adjustable mounting bracket for removably mounting a bicycle axle thereto, the bracket surmounted the mounting bar substantially coaxial with the mounting bar;
(d) means for detachably locking a bicycle axle to the mounting bracket; and
wherein, when deployed, the bicycle wheel is disposed substantially parallel to the front wheel forks of the bicycle.
